(19) United States
(12) Patent Application Publication
(10) Pub. No.: US 2024/0265668 A1
(43) Pub. Date: Aug. 8, 2024

(54) STORAGE MEDIUM STORING IMAGE EVALUATION PROGRAM AND IMAGE EVALUATION METHOD

(71) Applicant: BROTHER KOGYO KABUSHIKI KAISHA, Nagoya (JP)

(72) Inventor: Kan ISHIMOTO, Seto (JP)

(73) Assignee: BROTHER KOGYO KABUSHIKI KAISHA, Nagoya (JP)

(21) Appl. No.: 18/421,545

(22) Filed: Jan. 24, 2024

(30) Foreign Application Priority Data
Feb. 8, 2023 (JP) 2023-017639

(51) Int. Cl. G06V 10/44; G06F 3/14; G06V 10/56; H04N 1/60

(52) U.S. Cl. CPC G06V 10/44; G06F 3/14; G06V 10/56; H04N 1/60

(57) ABSTRACT

A non-transitory computer-readable storage medium storing an image evaluation program including a set of instructions for an image evaluation apparatus including a display and a controller. The set of instructions, when executed by the controller, causing the image evaluation apparatus to perform: acquiring image data representing an image; acquiring an evaluation condition for determining whether the image data is suitable as data serving as a source for generating processing data used for processing a sheet-like workpiece by a processing apparatus, from a viewpoint of at least ease of processing when the workpiece is processed in accordance with the processing data generated based on the image data or reproducibility of the image; acquiring a feature amount of the image data, the feature amount corresponding to the evaluation condition; and controlling the display to display a value corresponding to the feature amount of the image data.

### REFERENCE TO RELATED APPLICATIONS

This application claims priority from Japanese Patent Application No. 2023-017639 filed on Feb. 8, 2023. The entire content of the priority application is incorporated herein by reference.

### BACKGROUND ART

An image evaluation apparatus evaluates whether an image automatically captured by a camera and so on is an image suitable for a purpose.

### SUMMARY

For example, an image evaluation apparatus includes image acquisition means, storage means, editing target identification means, and scoring means. The storage means stores an image and attribute information of an editing target. The editing target identification means collates the image with the attribute information of the editing target and identifies an image including the editing target from the image. The scoring means combines a plurality of images including the editing target to score the images, and selects an image whose score exceeds a threshold.

However, there is a demand for a technique for evaluating whether arbitrary image data selectable by a user is suitable as data serving as a source for generating data used in a processing apparatus configured to process a sheet-like workpiece.

In view of the foregoing, an example of an object of this disclosure is to provide an image evaluation program and an image evaluation method for evaluating whether arbitrary image data selectable by a user is suitable as data serving as a source for generating data used in a processing apparatus configured to process a sheet-like workpiece.

According to one aspect, this specification discloses a non-transitory computer-readable storage medium storing an image evaluation program including a set of instructions for an image evaluation apparatus including a display and a controller. The set of instructions, when executed by the controller, causes the image evaluation apparatus to perform acquiring image data representing an image. Thus, the image evaluation apparatus acquires the image data representing the image. The set of instructions, when executed by the controller, causes the image evaluation apparatus to perform acquiring an evaluation condition for determining whether the image data is suitable as data serving as a source for generating processing data used for processing a sheet-like workpiece by a processing apparatus. The evaluation condition is a condition for determining whether the image data is suitable from a viewpoint of at least ease of processing when the workpiece is processed in accordance with the processing data generated based on the image data or reproducibility of the image. Thus, the image evaluation apparatus acquires the evaluation condition. The set of instructions, when executed by the controller, causes the image evaluation apparatus to perform acquiring a feature amount of the image data. The feature amount corresponds to the evaluation condition. Thus, the image evaluation apparatus acquires the feature amount of the image data. The set of instructions, when executed by the controller, causes the image evaluation apparatus to perform controlling the display to display a value corresponding to the feature amount of the image data. Thus, the display of the image evaluation apparatus displays the value corresponding to the feature amount of the image data. The image evaluation program causes the display of the image evaluation apparatus to display a value corresponding to the feature amount, thereby contributing to improvement in convenience of a user when selecting image data serving as a source for generating processing data. The user of the image evaluation apparatus determines whether the image data is suitable as data serving as a source for generating the processing data by referring to the value corresponding to the feature amount.

The technology disclosed in the present specification may be realized in various aspects, and may be realized in the form of, for example, an image evaluation method and an image evaluation apparatus, a computer program for realizing the functions of the method or apparatus, a storage medium (for example, a non-transitory storage medium) in which the computer program is stored, and so on.

### BRIEF DESCRIPTION OF DRAWINGS

FIG. 1 is a block diagram showing a schematic configuration of a data generation system 5 including a terminal apparatus 1, an embroidery sewing machine 2, and a printer 4.

FIG. 2 is an explanatory diagram of folders 21 to 26 stored in an image data storage area 20 of a memory 14 of the terminal apparatus 1 and images P1 to P3 stored in the folder 22.

FIG. 3 is a flowchart of an image evaluation process.

FIG. 4 is a flowchart of a rating calculation process executed in the image evaluation process of FIG. 3.

FIG. 5 is an explanatory diagram of a screen G1 for selecting an image group to be evaluated and a screen G2 on which images P1 to P3 to be evaluated are sorted in descending order of rating and displayed.

FIG. 6 is a flowchart of a rating calculation process.

FIG. 7 is a flowchart of a rating calculation process.

FIG. 8 is a flowchart of a rating calculation process.

FIG. 9 is a flowchart of a rating calculation process.

FIG. 10 is an explanatory diagram showing an example of same-color sections, a line segment, and constituent points.

FIG. 11 is an explanatory diagram showing another example of same-color sections, line segments, and constituent points.

### DESCRIPTION

Embodiments of the present disclosure will be described with reference to the drawings. As shown in FIG. 1, a data generation system 5 (hereinafter, referred to as “system 5”) includes a terminal apparatus 1, an embroidery sewing machine 2, and a printer 4. The terminal apparatus 1 is a well-known tablet type terminal apparatus or a multifunctional mobile phone (so-called smartphone). The embroidery sewing machine 2 is a household sewing machine or a multi-needle sewing machine configured to perform embroidery sewing. The printer 4 is a printer configured to print on a work cloth. The terminal apparatus 1 of the system 5 has a function of evaluating whether arbitrary image data selected by a user is suitable as data serving as a source for generating processing data used for processing a sheet-like workpiece by a processing apparatus. The evaluation is performed from the viewpoint of at least ease of processing when the workpiece is processed in accordance with the processing data generated based on the image data or reproducibility of an image. The processing apparatus of the present embodiment is the embroidery sewing machine 2, and the processing data is stitch data for sewing an embroidery pattern on a sheet-like sewing object such as a work cloth. The terminal apparatus 1 generates stitch data for embroidering a pattern in an image based on image data selected by the user, and outputs the generated stitch data to the embroidery sewing machine 2 via a network 3. The embroidery sewing machine 2 performs embroidery sewing based on the stitch data output from the terminal apparatus 1. The terminal apparatus 1 generates print data based on image data selected by the user and outputs the generated print data to the printer 4 via the network 3. The printer 4 prints on the work cloth based on the print data output from the terminal apparatus 1.

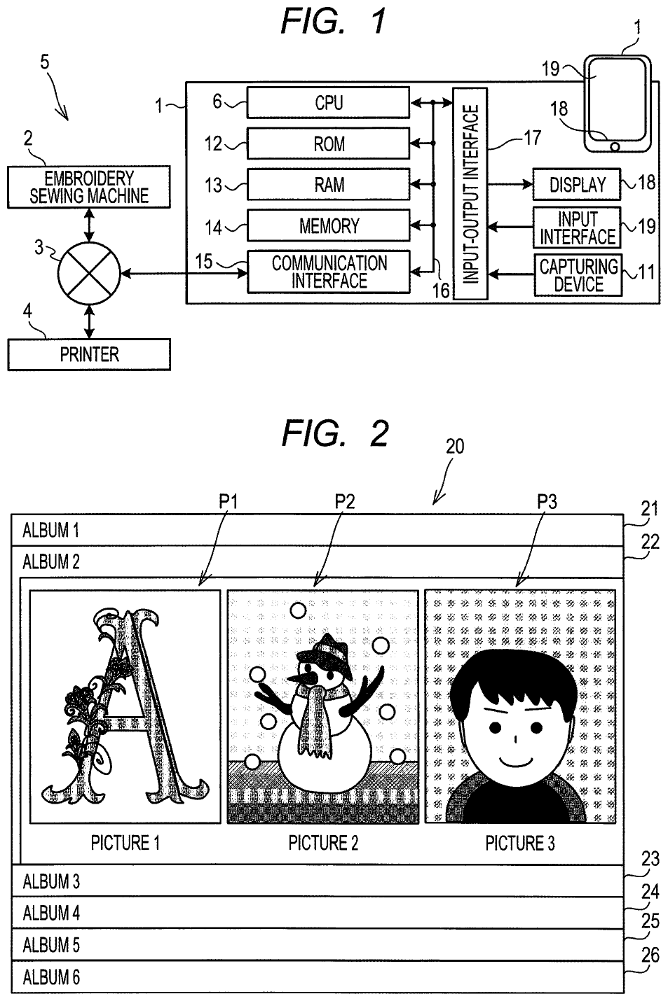

The terminal apparatus 1 includes a CPU 6, a ROM 12, a RAM 13, a memory 14, a communication interface 15, and an input-output interface 17. The CPU 6 controls the terminal apparatus 1. The CPU 6 is electrically connected to the ROM 12, the RAM 13, the memory 14, the communication interface 15, and the input-output interface 17 via a bus 16. The ROM 12 stores various programs and setting values. The RAM 13 stores temporary data. The memory 14 is a nonvolatile storage device. The memory 14 includes an image data storage area 20 shown in FIG. 2. The memory 14 stores an image evaluation program and various setting values that are necessary for executing an image evaluation process described later. The communication interface 15 is an interface for connecting the terminal apparatus 1 to the network 3. The CPU 6 performs data transmission and reception with other apparatuses (for example, the embroidery sewing machine 2 and the printer 4) connected to the network 3 via the communication interface 15. The input-output interface 17 is connected to a display 18, an input interface 19, and a capturing device 11. The display 18 is, for example, a liquid crystal display. The input interface 19 is, for example, a touch panel, and is used when various instructions are input. The capturing device 11 is, for example, a well-known CMOS image sensor.

The image evaluation process executed by the terminal apparatus 1 will be described with reference to FIGS. 2 to 5 by using a specific example of FIG. 2. The image data storage area 20 shown in FIG. 2 stores image data separately in a plurality of folders 21 to 26. The names of the folders 21 to 26 are ALBUM1 to ALBUM6, respectively. The folder 22 stores image data corresponding to images P1 to P3. The names of the images P1 to P3 are PICTURE 1 to PICTURE 3, respectively. Each image data is composed of a plurality of pixel data. Each pixel data corresponds to a pixel arranged in a two-dimensional matrix forming the image, and includes color information represented by RGB gradation values. The image P1 is an illustration represented by eight colors, with a white background. The image P2 is a photograph of a snowman arranged outdoors during snowfall, which is captured by the capturing device 11. The image P3 is a photograph of a person captured by the capturing device 11. The images of the image data stored in the image data storage area 20 are, for example, images selected from among an image captured by the capturing device 11, an image acquired from an external device via the communication interface 15, and an image created by the user using a drawing application. That is, the images may be a photograph or an illustration. In response to acquiring an instruction to start the image evaluation process from the user after the power is turned on, the CPU 6 of the terminal apparatus 1 reads the image evaluation program stored in the memory 14 out to the RAM 13. The CPU 6 reads the setting values necessary for the image evaluation process from the ROM 12 or the memory 14 out to the RAM 13. The CPU 6 executes the image evaluation process having the following steps in accordance with instructions included in the image evaluation program read to the RAM 13.

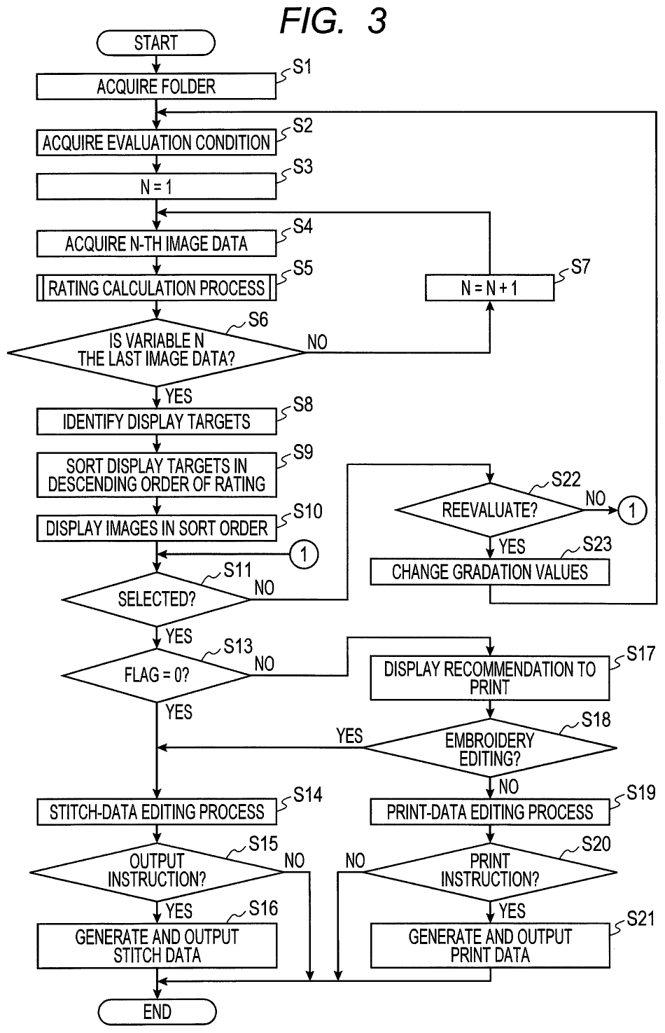

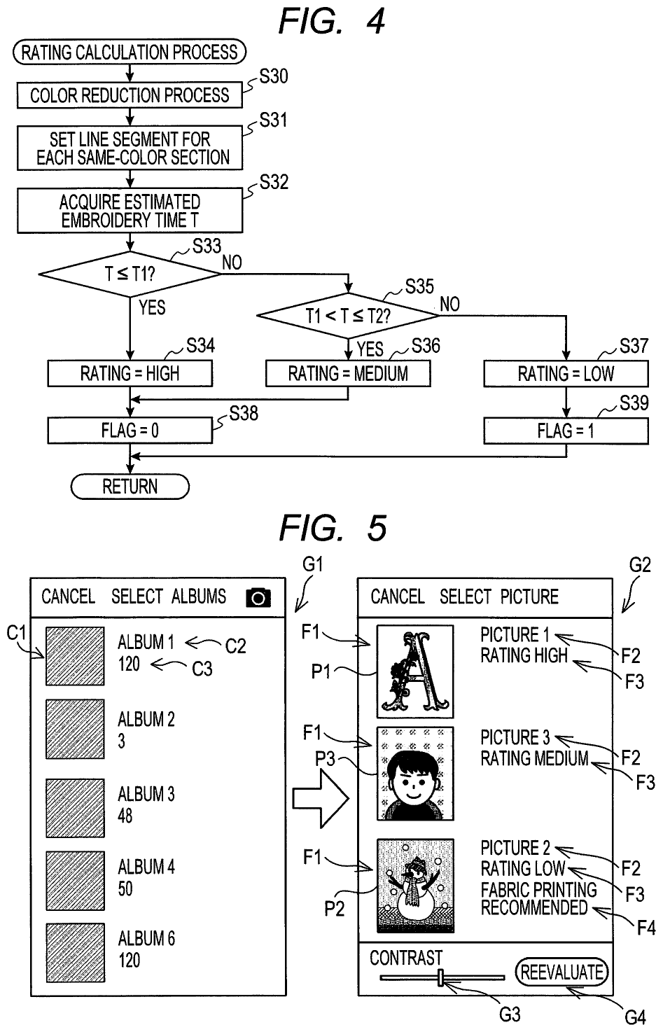

As shown in FIG. 3, in the image evaluation process, the CPU 6 displays a screen G1 of FIG. 5 on the display 18. The screen G1 displays an icon C1, a name C2, and a number of images C3 stored in the folder, for each of the folders 21 to 26 stored in the image data storage area 20. The name C2 and the number of images C3 are arranged on the right of the icon C1. Each folder stores a plurality of images. The user selects one or more folders from among the six folders 21 to 26 displayed on the screen G1. The CPU 6 acquires one or more folders selected by the user as a folder in which an image group to be evaluated is stored (S1). In the specific example, the CPU 6 acquires the folder 22 in which the three images P1 to P3 are stored.

The CPU 6 acquires an evaluation condition (S2). The evaluation condition includes one or more conditions set from a viewpoint of at least the ease of a sewing operation when an embroidery pattern is sewn on a sewing workpiece in accordance with stitch data generated based on image data, or the reproducibility of an image by the embroidery pattern. The evaluation condition may be one condition or a combination of a plurality of conditions. The evaluation condition may be a condition set in advance or a condition set by the user. An evaluation result (rating) may be represented by a numerical value or may be represented by a degree such as high, medium, and low in descending order of the rating. The evaluation condition of the present example is a condition for evaluating the ease of a sewing operation in a case where an embroidery pattern is sewn on a sewing workpiece, based on an estimated embroidery time in a case where stitch data is generated based on image data. The CPU 6 sets a rating to the image data in three stages of high, medium, and low according to the estimated embroidery time. In the present example, the evaluation condition is stored in advance in the memory 14. In S2, the CPU 6 acquires the evaluation condition from the memory 14.

The CPU 6 sets 1 as a variable N for sequentially reading image data in the folder acquired in S1 (S3). The CPU 6 acquires N-th image data (S4). When the variable N is 1, the CPU 6 of the present example acquires image data of the image P1. The CPU 6 executes a rating calculation process for the image data acquired in S4 (S5). In the rating calculation process, a process is executed for evaluating whether each of the image data stored in the folder acquired in S1 is suitable as a source for generating processing data used for processing a sheet-like workpiece by a processing apparatus (the embroidery sewing machine 2 in this embodiment), in accordance with the evaluation condition acquired in S2. The CPU 6 evaluates whether each of the image data is suitable as a source for generating stitch data (sewing data), in accordance with the evaluation condition acquired in S2.

As shown in FIG. 4, the CPU 6 performs a color reduction process based on the gradation values of each of the plurality of pixels (S30). The color reduction process may be performed by any method, for example, a median cut method. When a minute region is formed in an original image by the color reduction process, for example, the minute region is integrated into another divided region by noise reduction. When the image P1 is subjected to the color reduction process, the number of colors of the image after the color reduction may remain eight. When the images P2 and P3 are subjected to the color reduction process, the number of colors of the images after the color reduction is 10 or more.

The CPU 6 sets, as a same-color section, a group of continuous pixels of the same color in the image after the color reduction process based on the gradation values of each of the plurality of pixels of the image after the color reduction process, and sets a line segment for each same-color section in accordance with a particular condition (S31). The particular condition may be set as appropriate in accordance with the size of an embroidery frame of the embroidery sewing machine 2 and a method of converting the color-reduced image into stitch data. The size of the embroidery frame of the embroidery sewing machine 2 may be acquired from the embroidery sewing machine 2 or may be input via the input interface 19. The method of converting the color-reduced image into the stitch data is selected from, for example, any one of auto punch, photo stitch, and cross stitch. The auto punch is a conversion method in a case where the same-color section is sewn with a particular stitch such as a tatami stitch. The photo stitch is a conversion method for representing a pattern by fine line-segment-shaped stitches such as line drawings. The cross stitch is a conversion method for representing a pattern with X-shaped stitches. When the conversion method is the auto punch, the particular condition further includes the type of the stitches that represent the same-color section, the extending direction of the stitches, the thread density, and so on. The type of the stitches may be selected as appropriate from among stitches such as tatami stitch and satin stitch. The particular condition may include a color for which stitches are not set, such as a specific color or a background color. The particular condition of the specific example is a condition that the auto punch is performed, stitches are not set on white background, and the same-color section is sewn by tatami stitch. The number of same-color sections in the color-reduced image is the largest for the image P2, the smallest for the image P1, and in the middle for the image P3. The number of line segments set in S31 is the largest for the image P2, the smallest for the image P1, and in the middle for the image P3.

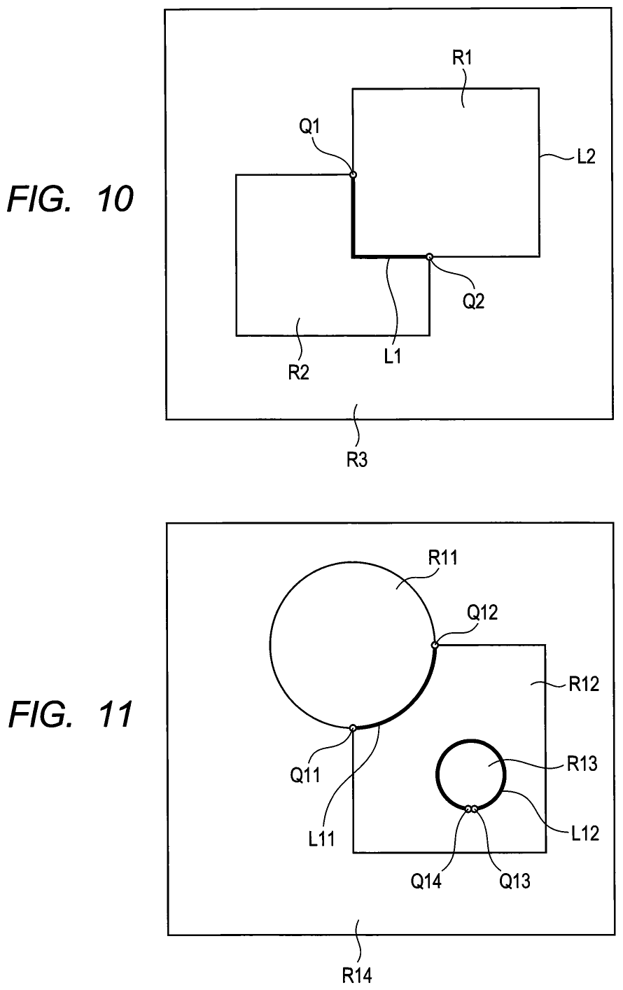

Here, the same-color section, the line segment, and constituent points will be described. The same-color section is a continuous region (section) of the same color (that is, a region formed by embroidering with one thread). The line segment is a boundary line on which same-color sections of different colors adjoin each other. The line segment may be a straight line segment, a bent line segment, or a curved line segment. For example, in FIG. 10, each of a red color section R1 and a green color section R2 is a same-color section. A line segment L1 is the boundary line on which the red color section R1 and the green color section R2 adjoin each other. A peripheral region R3 indicates a fabric on which embroidery is performed. In this specification, a boundary line between thread and fabric (for example, a line L2) is not a line segment. The line segment is a boundary line on which threads of different colors adjoin each other. End points (the starting point and the end point) of the line segment L1 are referred to as constituent points Q1 and Q2. FIG. 11 shows another example. In FIG. 11, a red color section R11 and a green color section R12 are arranged inside a peripheral region R14 indicating a fabric. A yellow color section R13 is arranged in the green color section R12. A line segment L11 is the boundary line on which the red color section R11 and the green color section R12 adjoin each other. A line segment L12 is the boundary line on which the green color section R12 and the yellow color section R13 adjoin each other. Constituent points Q11 and Q12 are end points of the line segment L11. As in snowballs around the snowman in FIG. 2, there are cases in which the line segment forms a ring (end points cannot be defined). In this case, the starting point and the end point are regarded as overlapping, the number of constituent points is counted as two, and the length of one round of the ring formed by the line segment is set as the length of the line segment. Thus, a ring-shaped line segment L12 has overlapping constituent points Q13 and Q14. Thus, one line segment includes two constituent points.

The CPU 6 acquires an estimated embroidery time T calculated according to the sum of the lengths of the line segments set in S31, the number of same-color sections, and the number of colors, as a feature amount of image data corresponding to the evaluation condition acquired in S2 (S32). The estimated embroidery time T is a value that is set based on the gradation values of each of the plurality of pixels of the image data acquired in S4. More specifically, the estimated embroidery time T may be acquired by generating stitch data based on the line segments set in S31 and calculating by a known method based on the generated stitch data. The estimated embroidery time T may be calculated by substituting the sum of the lengths of the line segments (and/or the number of the line segments) set in S31, the number of same-color sections, and the number of colors into a particular formula. The particular formula may be: the estimated embroidery time T=(a first coefficient)×(the sum of the lengths of the line segments or the number of the line segments)+(a second coefficient)×(the number of same-color sections)+(a third coefficient)×(the number of colors). The CPU 6 may calculate the estimated embroidery time T by acquiring the model of the embroidery sewing machine 2 and the color of the currently-attached thread from either the embroidery sewing machine 2 or the input interface 19. In general, the smaller the sum of the lengths of the line segments (and/or the number of the line segments) set in S31, the shorter the estimated embroidery time T. The smaller the number of used thread colors, the shorter the estimated embroidery time T. The smaller the number of same-color sections, the shorter the estimated embroidery time T.

The CPU 6 determines whether the estimated embroidery time T is shorter than or equal to a threshold T1 (S33). When the estimated embroidery time T is shorter than or equal to the threshold T1 (S33: YES), the CPU 6 sets “high” as the rating of the N-th image data (S34). The threshold T1 and a threshold T2 described later may be set in advance or may be set by the user. When the estimated embroidery time T is not shorter than or equal to the threshold T1 (S33: NO), the CPU 6 determines whether the estimated embroidery time T is longer than the threshold T1 and shorter than or equal to the threshold T2 (S35). The threshold T2 is greater than the threshold T1. When the estimated embroidery time T is longer than the threshold T1 and shorter than or equal to the threshold T2 (S35: YES), the CPU 6 sets “medium” as the rating of the N-th image data (S36). After S34 or S36, the CPU 6 set the flag to 0 for the N-th image data (S38). The flag is used in a process of determining whether to recommend printing the pattern represented by the N-th image data on the work cloth by the printer 4, rather than performing embroidery sewing. The terminal apparatus 1 of the present example does not recommend fabric printing when the flag is 0, and recommends fabric printing when the flag is 1.

When the estimated embroidery time T is longer than the threshold T2 (S35: NO), the CPU 6 sets “low” as the rating of the N-th image data (S37), and sets the flag to 1 (S39). After S38 or S39, the CPU 6 ends the rating calculation process and returns the processing to the image evaluation process in FIG. 3.

After S5, the CPU 6 determines whether the variable N is the last image data stored in the folder acquired in S1 (S6). When the variable N is not the last image data (S6: NO), the CPU 6 increments the variable N by 1 (S7), and returns the processing to S4. In the specific example, the CPU 6 sets the rating “high” to the image P1 (S34), sets the rating “low” to the image P2 (S37), and sets the rating “medium” to the image P3 (S36). The CPU 6 sets the flags of the images P1 and P3 to 0 (S38), and sets the flag of the image P2 to 1 (S39).

When the variable N is the last image data (S6: YES), the CPU 6 identifies images of a display target based on the rating calculated in S5 (S8). The method of identifying the display target may be appropriately set. For example, the CPU 6 may set all images evaluated in S5 as the display target, or may set a particular number of images in descending order of the rating among all images evaluated in S5 as the display target, or may set images evaluated at a particular rating or higher among all images evaluated in S5 as the display target. In the specific example, the CPU 6 sets all images for which rating is calculated in S5 as the display target.

The CPU 6 sorts the display targets identified in S8 in descending order of the rating calculated in S5 (S9). In the specific example, the images are sorted in descending order of the rating, that is, the image P1, the image P3, and the image P2. The CPU 6 displays a screen G2 in which the images are arranged in the sort order acquired in S9 on the display 18 (S10). The screen G2 of FIG. 5 displays a thumbnail image F1, an image name F2, and a rating F3 in association with each of the image data included in the folder 22 acquired in S1. The image name F2 and the rating F3 are arranged on the right side of the thumbnail image F1. In the image P2 associated with the flag 1 among the images P1 to P3 displayed on the screen G2, a message F4 that recommends printing on a work cloth rather than using for generating stitch data is arranged below the rating F3. The screen G2 further includes a bar G3 and a key G4. The bar G3 instructs to change contrast as a parameter of the images displayed on the screen G2. The parameter may be any parameter used for changing the gradation values of the plurality of pixels, in addition to/instead of the contrast. The key G4 instructs to calculate the rating again under the condition of the contrast specified by the bar G3. When the user finds image data for which the user wants to create stitch data with reference to the screen G2, the user selects the thumbnail image F1 of the image serving as the source of the stitch data. When the user wants to recalculate the rating under the condition of a changed contrast, the user operates the bar G3 and then presses the key G4 to instruct to calculate the rating again.

The CPU 6 determines whether an instruction to select any thumbnail image F1 in the screen G2 is detected via the input interface 19 (S11). When the instruction to select the thumbnail image F1 is not detected (S11: NO), the CPU 6 determines whether a press on the key G4 is detected via the input interface 19 (S22). When the press on the key G4 is not detected (S22: NO), the CPU 6 returns the processing to S11. When the press on key G4 is detected (S22: YES), the CPU 6 changes the gradation values of each image in one or more folders acquired in S1 in accordance with the value of the parameter set in the bar G3 (S23). The CPU 6 returns the processing to S2, and performs a process of calculating a rating using the image data in which the gradation values have been changed under the condition set in the bar G3, and displaying the calculated rating on the display 18 (from S2 to S10).

When the thumbnail image F1 of the image serving as the source of stitch data is selected from among the plurality of images displayed on the screen G2 (S11: YES), the CPU 6 determines whether the flag is 0 (S13). When the image P1 or the image P3 is selected in S11, the flag is 0 (S13: YES), and thus the CPU 6 executes a stitch-data editing process (S14). In the stitch-data editing process, processes for editing stitch data, such as movement, rotation, enlargement/reduction, and color change, are executed based on the color-reduced image data selected in S11. The CPU 6 determines whether a sewing output instruction to output the stitch data edited in S14 to the embroidery sewing machine 2 is detected via the input interface 19 (S15). When the sewing output instruction is detected (S15: YES), the CPU 6 generates stitch data edited in S14, and outputs the generated stitch data to the embroidery sewing machine 2 via the communication interface 15 (S16). The stitch data may be generated appropriately by a known method. For example, the CPU 6 may generate the stitch data including the sewing order, coordinate data of needle drop points, and thread color data, by setting the needle drop points at particular intervals on the line segments set in S31 and determining the order of connecting the needle drop points set for each same-color section. In the embroidery sewing machine 2, a process is executed to receive the stitch data that is output from the terminal apparatus 1, and a process is executed to sew an embroidery pattern on the sewing workpiece that is held by the embroidery frame, based on the received stitch data. When the sewing output instruction is not detected (S15: NO), or after S16, the CPU 6 ends the image evaluation process.

When the image P2 is selected in S11, the flag is 1 (S13: NO), and thus the CPU 6 displays a message on the display 18 indicating that the selected image is more suitable to be printed on the work cloth than to be used as the source of the stitch data (S17). The CPU 6 determines whether an instruction for embroidery editing is detected via the input interface 19 (S18). When the instruction for embroidery editing is detected (S18: YES), the CPU 6 performs S14 on the image data selected in S11 (S14). When the instruction for embroidery editing is not detected (S18: NO), the CPU 6 performs a print-data editing process (S19). In the print-data editing process, a process of editing print data for printing on the work cloth is executed based on the color-reduced image data selected in S11 or the image data before color reduction acquired in S4. The CPU 6 determines whether a print output instruction to output the print data edited in S19 to the printer 4 is detected via the input interface 19 (S20). When the print output instruction is detected (S20: YES), the CPU 6 generates the print data edited in S19 and outputs the generated print data to the printer 4 via the communication interface 15 (S21). The printer 4 performs a process of receiving the print data output from the terminal apparatus 1 and a process of printing the image edited in S19 on the work cloth based on the received print data. When the print output instruction is not detected (S20: NO), or after S21, the CPU 6 ends the image evaluation process.

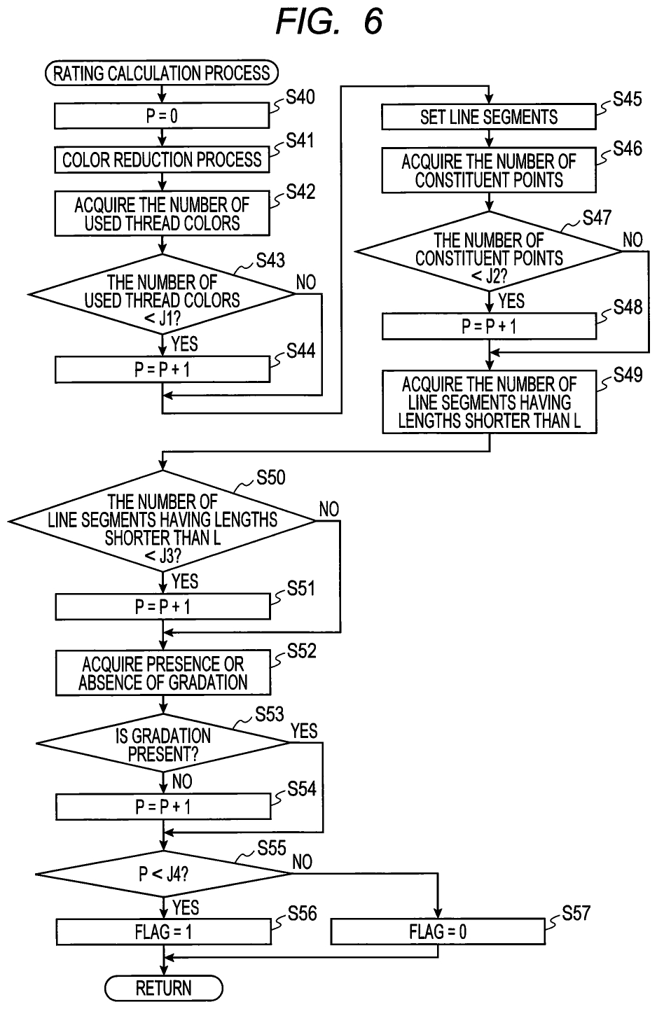

The rating calculation process of the above-described embodiment may be changed as appropriate. The rating calculation process of a first modification will be described with reference to FIG. 6 using the specific example of FIG. 2. The rating of the first modification is represented by an integer of 0 to 4, and the larger the value, the higher the rating. The rating calculation process for the images P1 to P3 is executed at different timings, but will be described in parallel for the sake of simplicity. The CPU 6 sets 0 as a variable P for calculating the rating (S40). The CPU 6 performs a color reduction process is on the N-th image data as in S30 (S41). The CPU 6 acquires the number of used thread colors that is the number of colors of threads used in embroidery sewing based on the colors after the color reduction in S41 (S42). The method of setting the thread colors may be set as appropriate, and for example, the thread color that is closest to each of the plurality of colors after the color reduction in S41 may be set as the used thread color. The number of used thread colors of the image P1 is eight. The number of used thread colors of the images P2 and P3 is ten or more. The CPU 6 determines whether the number of used thread colors acquired in S42 is less than a threshold J1 (S43). The number of used thread colors in a case where an embroidery pattern is sewn by the embroidery sewing machine 2 is normally set to approximately ten. The threshold J1 is set in consideration of a normal number of used thread colors. For the image P1, it is determined that the number of used thread colors is less than the threshold J1 (S43: YES), and the CPU 6 increments the variable P by 1 (S44), and then executes S45. For the images P2 and P3, it is determined that the number of used thread colors is greater than or equal to the threshold J1 (S43: NO), and the CPU 6 sets line segments in the image data that has been subjected to the color reduction process (S45), similarly to S31. The CPU 6 acquires the number of constituent points, where both ends of the line segment set in S45 are set as the constituent points (S46). The CPU 6 determines whether the number of the constituent points acquired in S46 is less than a threshold J2 (S47). In the images P1 and P3, it is determined that the number of constituent points is less than the threshold J2 (S47: YES), and the CPU 6 increments the variable P by 1 (S48) and then executes S49.

In the image P2, it is determined that the number of the constituent points is greater than or equal to the threshold J2 (S47: NO), and the CPU 6 acquires the number of line segments having lengths shorter than L among the line segments set in S45 (S49). The CPU 6 determines whether the number of line segments having lengths shorter than L acquired in S49 is less than a threshold J3 (S50). In the images P1 and P3, it is determined that the number of line segments having lengths shorter than L is less than the threshold J3 (S50: YES), and the CPU 6 increments the variable P by 1 (S51) and then executes S52. In the image P2, it is determined that the number of line segments having lengths shorter than L is greater than or equal to the threshold J3 (S50: NO), and the CPU 6 acquires the presence or absence of gradation as the amount corresponding to the gradation of the image data for which color reduction is performed in S41 (S52). The presence or absence of gradation is acquired as explained below. For example, in order to check the presence or absence of fine (small) regions, the CPU 6 acquires the length of each line segment in an image on which color reduction has been performed. For example, in a case a full-color image such as a photograph is reduced to eight digital colors to form an embroidery pattern, an image formed by a large number of small regions having different colors is obtained to express gradation. Here, when the number of line segments shorter than a particular length is larger than a particular number, the CPU 6 determines that gradation is present. The CPU 6 determines whether the presence of gradation is acquired in S52 (S53). In the images P1 and P3, the absence of gradation is acquired (S53: NO), and the CPU 6 increments the variable P by 1 (S54) and then execute S55. In the image P2, the presence of gradation is acquired (S53: YES), and the CPU 6 determines whether the variable P is less than a threshold J4 (S55). The threshold J4 is set to any value from 1 to 3 in consideration of the range of the variable P. In the image P2, it is determined that the variable P is less than the threshold J4 (S55: YES), and the CPU 6 sets the flag to 1 (S56). In the images P1 and P3, it is determined that the variable P is not less than the threshold J4 (S55: NO), and the CPU 6 sets the flag to 0 (S57). By the rating calculation process of the first modification, the CPU 6 sets the rating of the image P1 to 4, sets the rating of the image P2 to 0, and sets the rating of the image P3 to 3. The CPU 6 sets the flags of the images P1 and P3 to 0, and sets the flag of the image P2 to 1.

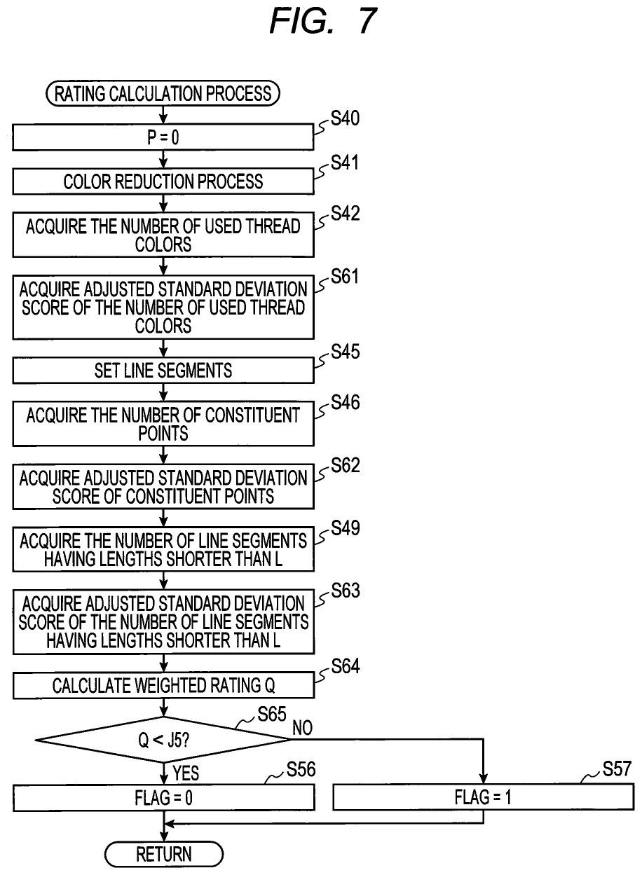

A rating calculation process of a second modification will be described with reference to FIG. 7. In FIG. 7, the same step numbers are assigned to the same processes as those in the rating calculation process of the first modification of FIG. 6. As shown in FIG. 7, the rating calculation process of the second modification is different from that of the first modification in that S61 is performed instead of S43 and S44, S62 is performed instead of S47 and S48, and S63 to S65 are performed instead of S50 to S55. Hereinafter, the description of the same processes as that of the first modification will be omitted, and processes different from those of the first modification will be described. In the second modification, the values acquired in each of S42, S46, and S49 are stored in the memory 14 in association with image data. In S61, the CPU 6 uses Equation (1) to acquire an adjusted standard deviation score K1 of the number of used thread colors acquired in S42 (S61).

$$Adjusted standard deviation score K 1 = ( current value - average value of values acquired in S 42 so far ) / ( standard deviation of values acquired in S 42 so far ) \times 10 + 50 \qquad Equation ( 1 )$$

Similarly, in S62, the CPU 6 acquires an adjusted standard deviation score K2 of the constituent points acquired in S46 (S62). In S63, the CPU 6 acquires an adjusted standard deviation score K3 of the number of line segments having lengths shorter than L acquired in S49 (S63). The CPU 6 calculates a weighted rating Q by using coefficients k1 to k3 and Equation (2) (S64). The coefficients k1 to k3 may be set in advance or may be set by the user. Each of the coefficients k1 to k3 may be a value that is automatically changed according to the tendency of rating of an image selected by the user of the terminal apparatus 1 in S11.

$$Rating Q = k 1 \times K 1 + k 2 \times K 2 + k 3 \times K 3 \qquad Equation ( 2 )$$

The CPU 6 determines whether the rating Q calculated in S64 is less than a threshold J5 (S65). The threshold J5 is set in consideration of the range of the rating Q. When the rating Q is less than the threshold J5 (S65: YES), the CPU 6 sets the flag to 1 (S56). When the rating Q is not less than the threshold J5 (S65: NO), the CPU 6 sets the flag to 0 (S57). According to the rating calculation process of the second modification, for example, the images are ranked in descending order of rating, that is, image P1, image P3, and image P2. The CPU 6 sets the flags of the images P1 and P3 to 0, and sets the flag of the image P2 to 1.

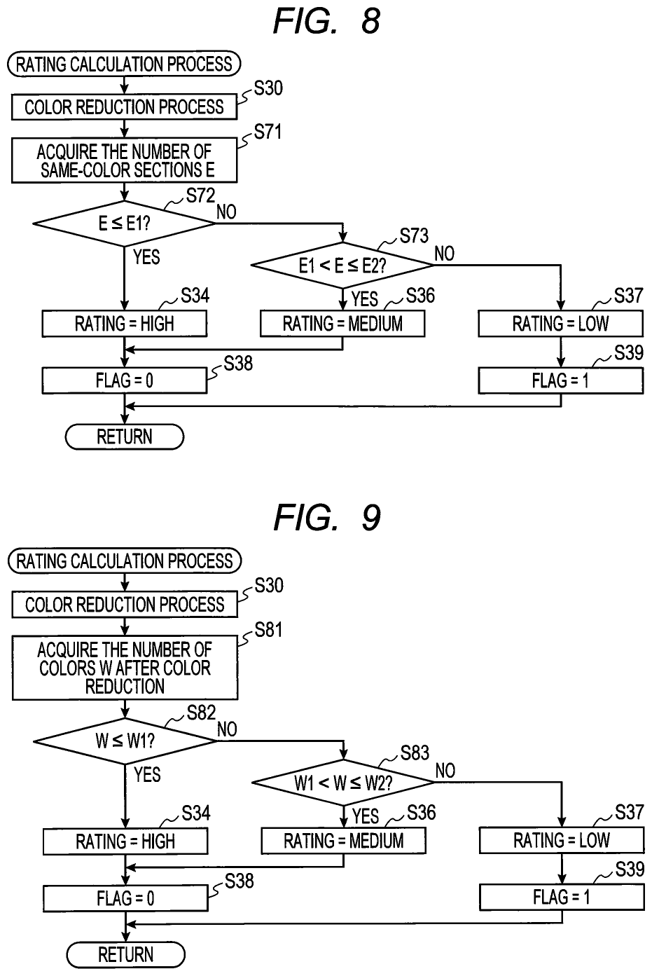

A rating calculation process of a third modification will be described with reference to FIG. 8. In FIG. 8, the same step numbers are assigned to the same processes as those in the rating calculation process of the embodiment of FIG. 4. As shown in FIG. 8, the rating calculation process of the third modification is different from the above-described embodiment in that S71 is performed instead of S31 and S32, S72 is performed instead of S33, and S73 is performed instead of S35. Hereinafter, the same processes as those of the above-described embodiment will not be described, and processes different from those of the embodiment will be described. In S71, the CPU 6 acquires a number E of same-color sections of the image for which color reduction has been performed in S30 (S71). In S72, the CPU 6 determines whether the number E acquired in S71 is less than or equal to a threshold E1 (S72). When the number E is less than or equal to the threshold E1 (S72: YES), the CPU 6 sets “high” as the rating of the N-th image data (S34). When the number E is not less than or equal to the threshold E1 (S72: NO), the CPU 6 determines whether the number E is greater than the threshold E1 and less than or equal to a threshold E2 (S73). The threshold E2 may be set to a value greater than the threshold E1 as appropriate. When the number E is greater than the threshold E1 and less than or equal to the threshold E2 (S73: YES), the CPU 6 sets “medium” as the rating of the N-th image data (S36). After S34 or S36, the CPU 6 sets the flag to 0 for the N-th image data (S38). When the number E is greater than the threshold E1 and is not less than or equal to the threshold E2, that is, when the number E is greater than the threshold E2 (S73: NO), the CPU 6 sets “low” as the rating of the N-th image data (S37) and sets the flag to 1 (S39). After S38 or S39, the CPU 6 ends the rating calculation process and returns the processing to the image evaluation process in FIG. 3.

A rating calculation process of a fourth modification will be described with reference to FIG. 9. In FIG. 9, the same step numbers are assigned to the same processes as those in the rating calculation process of the embodiment of FIG. 4. As shown in FIG. 9, the rating calculation process of the fourth modification is different from the above-described embodiment in that S81 is performed instead of S31 and S32, S82 is performed instead of S33, and S83 is performed instead of S35. Hereinafter, the same processes as those of the above-described embodiment will not be described, and processes different from those of the embodiment will be described. In S81, the CPU 6 acquires a number W of colors of the image data after the color reduction in S30 (S81). In S82, the CPU 6 determines whether the number W acquired in S81 is less than or equal to a threshold W1 (S82). When the number W is less than or equal to the threshold W1 (S82: YES), the CPU 6 sets “high” as the rating of the N-th image data (S34). When the number W is not less than or equal to the threshold W1 (S82: NO), the CPU 6 determines whether the number W is greater than the threshold W1 and less than or equal to a threshold W2 (S83). The threshold W2 may be set to a value greater than the threshold W1 as appropriate. When the number W is greater than the threshold W1 and less than or equal to the threshold W2 (S83: YES), the CPU 6 sets “medium” as the rating of the N-th image data (S36). After S34 or S36, the CPU 6 sets the flag to 0 for the N-th image data (S38). When the number W is greater than the threshold W1 and is not less than or equal to the threshold W2, that is, when the number W is greater than the threshold W2 (S83: NO), the CPU 6 sets “low” as the rating of the N-th image data (S37) and sets the flag to 1 (S39). After S38 or S39, the CPU 6 ends the rating calculation process and returns the processing to the image evaluation process in FIG. 3.

In the above-described embodiment, the terminal apparatus 1, the display 18, the CPU 6, and the embroidery sewing machine 2 are examples of an image evaluation apparatus, a display, a controller, and a processing apparatus, respectively. S4 in FIG. 3 is an example of an image-data acquisition process and an image-data acquisition step of the present disclosure. S2 is an example of an evaluation condition acquisition process and an evaluation condition acquisition step of the present disclosure. S32 is an example of a feature amount acquisition process and a feature amount acquisition step of the present disclosure. S34, S36, and S37 are an example of an evaluation process of the present disclosure. S10 is an example of a display control process and a display control step of the present disclosure. S31 is an example of a line segment setting process of the present disclosure. S30 is an example of a color reduction process of the present disclosure.

The terminal apparatus 1 of the above-described embodiment includes the display 18 and the CPU 6. The image evaluation program includes instructions for causing the CPU 6 to execute the following processes of S4, S2, S32, and S10. The CPU 6 acquires image data representing an image (S4). The CPU 6 acquires an evaluation condition for evaluating whether the image data is suitable as data serving as a source for generating processing data used for processing a sheet-like workpiece by a processing apparatus, from the viewpoint of at least the ease of processing the workpiece according to the processing data generated based on the image data or the reproducibility of the image (S2). The CPU 6 acquires the feature amount of the image data corresponding to the evaluation condition (S32). The CPU 6 displays a value corresponding to the feature amount of the image data on the display 18 (S10). The image evaluation program causes the display 18 of the terminal apparatus 1 to display a value corresponding to the feature amount, thereby contributing to improvement in convenience of the user when selecting image data serving as a source for generating processing data. The user of the terminal apparatus 1 determines whether the image data is suitable as data serving as a source for generating the processing data by referring to the value corresponding to the feature amount.

The image data of the above-described embodiment includes the gradation values of each of the plurality of pixels constituting the image. In S32, the feature amount of image data corresponding to the evaluation condition is acquired based on the gradation values of each of the plurality of pixels. According to the image evaluation program, the CPU 6 assigns, to the image data, an evaluation result indicating whether the image data is suitable as data serving as a source for generating processing data, based on the feature amount (from S33 to S37). The CPU 6 controls the display 18 to display the evaluation result as a value corresponding to the feature amount. The terminal apparatus 1 acquires the feature amount of the image data corresponding to the evaluation condition based on the gradation values of each of the plurality of pixels. The user of the terminal apparatus 1 determines whether the image data is suitable as data serving as a source for generating the processing data by referring to the evaluation result.

The processing apparatus of the above-described embodiment is the embroidery sewing machine 2 configured to perform embroidery sewing on a sewing workpiece, and the processing data is stitch data used by the embroidery sewing machine. The user of the terminal apparatus 1 determines whether the image data is suitable as data serving as a source for generating the stitch data by referring to the evaluation result. The terminal apparatus 1 contributes to improving the convenience of the user when selecting the image data serving as the source for generating the stitch data.

In S71 of the image evaluation program of the third modification, the CPU 6 acquires the number of same-color sections that are continuous regions represented by the same color included in an image as the feature amount, based on the gradation values of each of the plurality of pixels (S71). In S34, S36, S37, S72, and S73, the CPU 6 sets a higher rating as the feature amount is smaller. In general, the more the number of same-color sections, the more complicated the processing of a workpiece by the processing apparatus. The terminal apparatus 1 contributes to saving the user's time and effort to acquire the number of same-color sections and to set a rating to image data in accordance with the number of same-color sections. By referring to the evaluation result, the user of the terminal apparatus 1 determines whether the image data is suitable as data serving as a source for generating stitch data from the viewpoint of ease of processing, based on the number of the same-color sections.

The CPU 6 that executes the image evaluation program of the first modification and the second modification executes a process of setting a plurality of line segments representing an image based on the gradation values of each of the plurality of pixels (S45). In S46 of the first modification, the CPU 6 acquires the number of line segments corresponding to the plurality of line segments set in S46 as the feature amount (S46). In S62 of the second modification, the CPU 6 acquires the number corresponding to the plurality of line segments set in S45 as the feature amount (S62). The terminal apparatus 1 contributes to saving the user's time and effort to acquire the number of line segments representing an image and to set a rating to image data in accordance with the number of line segments representing the image. By referring to the evaluation result, the user of the terminal apparatus 1 determines whether the image data is suitable as data serving as a source for generating stitch data from the viewpoint of ease of processing, based on the number of the line segments.

The CPU 6 that executes the image evaluation program of the first modification and the second modification sets a higher rating as the feature amount set as the number corresponding to the plurality of line segments set in S45 is smaller (S47, S48, S64). In general, the more the number of line segments representing an image, the more complicated the process of processing a workpiece by a processing apparatus. By referring to the evaluation result, the user of the terminal apparatus 1 determines whether the image data is suitable as data serving as a source for generating stitch data from the viewpoint of ease of processing, based on the number of the line segments.

In S49 of the image evaluation program of the first modification and the second modification, the CPU 6 acquires, as the feature amount, the number of line segments having lengths shorter than a particular value among the plurality of line segments (S49). In S50 and S51 of the first modification, the CPU 6 sets a higher rating as the feature amount is smaller (S50 and S51). In S64 of the second modification, the CPU 6 sets a higher rating as the feature amount is smaller (S64). In general, the more the number of short line segments representing an image, the more complicated the process of processing a workpiece by a processing apparatus. The terminal apparatus 1 contributes to saving the user's time and effort to acquire the number of line segments representing an image and having lengths shorter than a particular value, and to set a rating to image data in accordance with the number of line segments having lengths shorter than the particular value. By referring to the evaluation result, the user of the terminal apparatus 1 determines whether the image data is suitable as data serving as a source for generating stitch data from the viewpoint of ease of processing, based on the number of line segments having lengths shorter than the particular value.

In S42 of the image evaluation program of the first modification and the second modification, the CPU 6 acquires the number corresponding to the colors included in the image as the feature amount based on the gradation values of each of the plurality of pixels. In the evaluation process of S43 and S44 of the first modification, the CPU 6 sets a higher rating as the feature amount is smaller (S50 and S51). In the evaluation process of S64, the CPU 6 of the second modification sets a higher rating as the feature amount is smaller (S64). In general, the more the number of colors of an image, the more complicated the process of processing a workpiece by a processing apparatus. The terminal apparatus 1 contributes to saving the user's time and effort to acquire the number corresponding to the colors included in the image and to set a rating to the image data according to the number corresponding to the colors included in the image. By referring to the evaluation result, the user of the terminal apparatus 1 determines whether the image data is suitable as data serving as a source for generating stitch data from the viewpoint of ease of processing, based on the number corresponding to the colors included in the image.

The CPU 6 that executes the image evaluation program of the fourth modification executes a color reduction process that reduces a plurality of colors representing an image to colors that can be processed by the processing apparatus, based on the gradation values of each of the plurality of pixels (S30). In S81, the CPU 6 acquires the number of colors of the image after the color reduction process as the feature amount, and sets a higher rating as the feature amount is smaller in S34, S36, S37, S82, and S83. The terminal apparatus 1 contributes to saving the user's time and effort to acquire the number of colors of the image after the color reduction process and to set a rating to the image data in accordance with the number of colors of the image after the color reduction process. By referring to the evaluation result, the user of the terminal apparatus 1 determines whether the image data is suitable as data serving as a source for generating stitch data from the viewpoint of ease of processing, based on the number of colors of the image when processed by the processing apparatus.

In S52 of the image evaluation program of the second modification, the CPU 6 acquires an amount corresponding to the gradation of colors included in the image as the feature amount, and in S53 and S54 sets a higher rating as the feature amount is smaller (S53 and S54). In general, when gradation is included in image data, processing becomes more complicated than when gradation is not included. The terminal apparatus 1 contributes to saving the user's time and effort to acquire the amount corresponding to the gradation of the colors included in the image and to set a rating to the image data according to the amount corresponding to the gradation. By referring to the evaluation result, the user of the terminal apparatus 1 determines whether the image data is suitable as data serving as a source for generating stitch data from the viewpoint of ease of processing and the reproducibility of the image, based on the amount corresponding to gradation of colors.

In S32 of the above-described embodiment, the CPU 6 acquires, as the feature amount, the estimated processing time for processing the workpiece by the processing apparatus in accordance with the processing data generated based on the image data (S32). In the specific example, the CPU 6 acquires, as the feature amount, the estimated embroidery time T for sewing on a sewing object by the embroidery sewing machine 2 in accordance with stitch data (S32). The terminal apparatus 1 contributes to saving the user's time and effort to acquire the estimated processing time and to set a rating to the image data in accordance with the estimated processing time. By referring to the evaluation result, the user of the terminal apparatus 1 determines whether the image data is suitable as data serving as a source for generating stitch data from the viewpoint of ease of processing, based on the estimated processing time.

In S32 of the above-described embodiment, the CPU 6 acquires, as the feature amount, the estimated processing time for processing the workpiece by the processing apparatus in accordance with the processing data indicating processing positions of line segments by a particular rule for each same-color section that is a continuous region represented by the same color included in an image, and in S32 to S37 sets a higher rating as the feature amount is smaller. By referring to the evaluation result, the user of the terminal apparatus 1 determines whether the image data is suitable as data serving as a source for generating stitch data from the viewpoint of ease of processing, based on the estimated processing time when the image is represented by the line segments by the particular rule for each same-color section.

In S10 of the above-described embodiment, the CPU 6 controls the display 18 to display a plurality of sets of images and evaluation results in association with each other in a list. The terminal apparatus 1 contributes to improvement of user convenience when comparing a plurality of sets of images and the evaluation results. The user of the terminal apparatus 1 selects an image of which image data is suitable as data serving as a source for generating stitch data, based on the plurality of sets of images and the evaluation results displayed in a list on the display 18.

In S9 and S10 of the above-described embodiment, the CPU 6 displays the plurality of sets of images and the evaluation results in a sorted manner in descending order of evaluation result. The terminal apparatus 1 improves the convenience of the user when selecting an image suitable as data serving as a source for generating stitch data, from among the plurality of sets of images and evaluation results displayed in a list on the display 18, compared with a case where the evaluation results are not sorted.

In S10 of the above-described embodiment, regarding an image of which the evaluation result indicates a lower rating than a particular rating, the CPU 6 controls the display 18 to display the evaluation result and information indicating that the image data is more suitable for printing by the printer 4 than for processing by the processing apparatus, in association with each other. The terminal apparatus 1 contributes to presenting an option other than processing by the processing apparatus to the user who is considering generating processing data based on image data. The user of the terminal apparatus 1 recognizes that the image data is more suitable for printing by the printer 4 than for processing by the processing apparatus.

The CPU 6 of the above-described embodiment executes a process of acquiring the condition for changing the gradation values of each of the plurality of pixels (S22) and a process of changing the gradation values of each of the plurality of pixels in accordance with the acquired condition (S23). In S5 after S23, the CPU 6 acquires the feature amount of image data corresponding to the evaluation condition based on the changed gradation values of each of the plurality of pixels. The terminal apparatus 1 contributes to improvement of user's convenience in selecting image data, compared with a case where the gradation value cannot be changed under a specified condition. The user of the terminal apparatus 1 confirms the evaluation result based on the image data of which gradation value has been changed under the specified condition.

While the image evaluation program and the image evaluation method of the present disclosure have been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described present disclosure are provided below.

The present disclosure may be implemented in various modes, and may be implemented in the form of, for example, a computer-readable storage medium storing an image evaluation program, an image evaluation apparatus, or an image evaluation system. The processing apparatus may be a cutting apparatus configured to cut a sheet-like object with a cutting blade, a plotter configured to perform drawing on a sheet-like medium, and so on. The processing data and the feature amount may be changed according to the processing apparatus. In a case where the processing apparatus is a cutting apparatus, the processing data is cutting data indicating a cutting position, and the feature amount may be selected from among an estimated cutting time, the number of sheets to be cut, a length of a cut line segment, and the number of sections to be cut. In a case where the processing apparatus is a plotter, the processing data is drawing data indicating a drawing position and a pen color, and the feature amount may be selected from among an estimated drawing time, the number of pen colors used for drawing, a length of a drawn line segment, and the number of sections to be drawn.

(A) The configuration of the terminal apparatus 1 configured to execute the image evaluation program may be changed as appropriate, and may be a PC, for example. The display 18 of the terminal apparatus 1 may be any display configured to display an image, and may be, for example, an organic EL display, a plasma display, a plasma tube array display, or an electronic paper display using electrophoresis and so on. The input interface 19 of the terminal apparatus 1 may be a keyboard, a mouse, a joystick, and so on, in addition to the touch panel.

(B) The image evaluation program including instructions for executing the processes of FIGS. 3 and 4 may be stored in a storage device of the terminal apparatus 1 before the CPU 6 of the terminal apparatus 1 executes the corresponding image evaluation program. Thus, the method of acquiring the image evaluation program, the path of acquiring the image evaluation program, and the device storing the program may be changed as appropriate. The image evaluation program executed by the terminal apparatus 1 may be received from another apparatus via a cable or wireless communication and stored in a storage device such as a memory. The other apparatuses include, for example, a PC and a server connected via a network.

(C) Each step of the image evaluation process is not limited to the example of being executed by the CPU 6, and a part or all of the steps may be executed by another electronic device (for example, an ASIC). Similarly, each step of the image evaluation process is not limited to the example of being executed by the CPU 6, and a part or all of the steps may be executed by another electronic apparatus. Each step of the image evaluation process may be performed by a plurality of electronic devices (for example, a plurality of CPUs) in a distributed manner. The order of the steps of the image evaluation process may be changed, and steps may be omitted or added as necessary. The following changes may be made to the image evaluation process as appropriate.

The evaluation condition acquired in S2 may be any condition for evaluating image data from the viewpoint of at least the ease of processing when the workpiece is processed in accordance with the processing date generated based on the image data or the reproducibility of the image, and may be changed as appropriate in consideration of the processing apparatus and the processing condition. For example, when performing evaluation using a plurality of conditions, the CPU 6 may set a higher rating as the final evaluation result to an image having a tendency that the evaluation result of each of the plurality of conditions is similar to that of an image selected in S11 by the user in the past, compared with an unsimilar image. In a case where the processing apparatus is the embroidery sewing machine 2 and a plurality of conditions are combined as the evaluation condition, the weight of each condition may be constant or may be different from each other. The terminal apparatus 1 may calculate the evaluation result by combining the following first to third conditions in descending order of weight, for example. The first condition is a condition that the rating is higher as the boundary value of a pattern in an image is clearer and the number of line segments to be set is smaller. The second condition is a condition that the rating is higher as the number of used thread colors is smaller. The third condition is a condition that the rating is higher as the number of the same-color sections is smaller.

The feature amount may be changed as appropriate according to the evaluation condition. The relationship between the feature amount and the rating may be changed as appropriate according to the feature amount. In a case where the feature amount is an amount related to gradation, the feature amount may be an amount corresponding to at least the area or the number of colors of the gradation portion. The value corresponding to the feature amount may be an evaluation result (rating) assigned based on the feature amount or the feature amount itself.

The CPU 6 may perform the processing from S2 to S10 by setting one or more particular images designated by the user among images in the folder acquired in S1 as the evaluation targets. The layout of the screen displayed on the display 18 may be changed as appropriate. The screen G2 may not include the name F2. The screen G2 may not directly display an evaluation result (rating “high”, “medium”, or “low”), but may indirectly display the evaluation result in the sort order. For example, the CPU 6 may sort and display images of the evaluation target in ascending order of the number of colors of the images before or after color reduction, based on the gradation values of each of the plurality of pixels (S10). In this case, the CPU 6 acquires the number of colors as the feature amount and sorts the images by the feature amount, thereby setting a higher rating to image data as the feature amount is smaller. In a case where the evaluation condition is a condition that a portion of the background color is not sewn, the CPU 6 may sort and display images of the evaluation target in ascending order of the area of colors other than the background color, based on the gradation values of each of the plurality of pixels (S10). In this case, the CPU 6 acquires the area of colors other than the background color as the feature amount and sorts the images by the feature amount, thereby setting a higher rating to image data as the feature amount is smaller. The CPU 6 may display evaluation targets on the display 18 without sorting the evaluation targets in descending order of rating. The CPU 6 may 6 may not display sets of images and ratings in a list, but may display one set or any number of sets in a screen at a time.

The CPU 6 may not display the information indicating that the image is more suitable for printing by the printer 4 in S10. In this case, the CPU 6 may omit the process of setting the flag and the process related to the flag. The CPU 6 may receive an instruction to change the gradation values of a plurality of pixels of image data based on a plurality of types of parameters in S22. The CPU 6 may skip S22 and S23, and may not receive a change of the gradation values of the plurality of pixels of image data. The CPU 6 may receive a change in the evaluation condition in S2. In this case, the CPU 6 may execute S3 to S10 based on the changed evaluation condition.

The image data may be vector data instead of raster data having the gradation values of each of the plurality of pixels. In a case where the image data includes vector data, the processing may be performed after the vector data is converted into raster data, or the processing may be performed by directly acquiring feature amounts such as the number of sections and the number corresponding to a plurality of line segments from numerical line data included in the vector data. The above modifications may be combined as appropriate as long as no inconsistency occurs.

What is claimed is:

1. A non-transitory computer-readable storage medium storing an image evaluation program including a set of instructions for an image evaluation apparatus comprising a display and a controller, the set of instructions, when executed by the controller, causing the image evaluation apparatus to perform:
acquiring image data representing an image;
acquiring an evaluation condition for determining whether the image data is suitable as data serving as a source for generating processing data used for processing a sheet-like workpiece by a processing apparatus, the evaluation condition being a condition for determining whether the image data is suitable from a viewpoint of at least ease of processing when the workpiece is processed in accordance with the processing data generated based on the image data or reproducibility of the image;
acquiring a feature amount of the image data, the feature amount corresponding to the evaluation condition; and
controlling the display to display a value corresponding to the feature amount of the image data.

2. The non-transitory computer-readable storage medium according to claim 1, wherein the image data includes a gradation value of each of a plurality of pixels forming the image;
wherein the acquiring the feature amount includes acquiring the feature amount of the image data corresponding to the evaluation condition based on the gradation value of each of the plurality of pixels;
wherein the set of instructions, when executed by the controller, causes the image evaluation apparatus to perform:
setting an evaluation result to the image data in accordance with the feature amount, the evaluation result indicating whether the image data is suitable as the data serving as the source for generating the processing data; and
wherein the controlling the display includes controlling the display to display the evaluation result as the value corresponding to the feature amount.

3. The non-transitory computer-readable storage medium according to claim 2, wherein the processing apparatus is an embroidery sewing machine configured to perform embroidery sewing on a sewing object; and
wherein the processing data is stitch data that is used by the embroidery sewing machine.

4. The non-transitory computer-readable storage medium according to claim 2, wherein the acquiring the feature amount includes acquiring a number of same-color sections as the feature amount based on the gradation value of each of the plurality of pixels, each of the same-color sections being a continuous region represented by a same color in the image; and
wherein the setting the evaluation result includes setting a higher rating to the image data as the feature amount is smaller.

5. The non-transitory computer-readable storage medium according to claim 2, wherein the set of instructions, when executed by the controller, causes the image evaluation apparatus to perform:
setting a plurality of line segments representing the image based on the gradation value of each of the plurality of pixels; and
wherein the acquiring the feature amount includes acquiring, as the feature amount, a number corresponding to the plurality of line segments.

6. The non-transitory computer-readable storage medium according to claim 5, wherein the setting the evaluation result includes setting a higher rating to the image data as the feature amount is smaller.

7. The non-transitory computer-readable storage medium according to claim 5, wherein the acquiring the feature amount includes acquiring, as the feature amount, a number of line segments having lengths shorter than a particular length among the plurality of line segment; and
wherein the setting the evaluation result includes setting a higher rating to the image data as the feature amount is smaller.

8. The non-transitory computer-readable storage medium according to claim 2, wherein the acquiring the feature amount includes acquiring, as the feature amount, a number corresponding to colors included in the image based on the gradation value of each of the plurality of pixels; and
wherein the setting the evaluation result includes setting a higher rating to the image data as the feature amount is smaller.

9. The non-transitory computer-readable storage medium according to claim 8, wherein the set of instructions, when executed by the controller, causes the image evaluation apparatus to perform color reduction of reducing a plurality of colors representing the image to colors processable by the processing apparatus, based on the gradation value of each of the plurality of pixels;
wherein the acquiring the feature amount includes acquiring, as the feature amount, a number of colors of the image after the color reduction is performed; and
wherein the setting the evaluation result includes setting a higher rating to the image data as the feature amount is smaller.

10. The non-transitory computer-readable storage medium according to claim 8, wherein the acquiring the feature amount includes acquiring, as the feature amount, an amount corresponding to gradation of colors included in the image; and
wherein the setting the evaluation result includes setting a higher rating to the image data as the feature amount is smaller.

11. The non-transitory computer-readable storage medium according to claim 2, wherein the acquiring the feature amount includes acquiring, as the feature amount, an estimated processing time for processing the workpiece by the processing apparatus in accordance with the processing data generated based on the image data.

12. The non-transitory computer-readable storage medium according to claim 11, wherein the acquiring the feature amount includes acquiring the estimated processing time as the feature amount, the estimated processing time being time for processing the workpiece by the processing apparatus in accordance with the processing data, the processing data indicating processing positions of line segments arranged with a particular rule for each of same-color sections, each of the same-color sections being a continuous region represented by a same color in the image; and
wherein the setting the evaluation result includes setting a higher rating to the image data as the feature amount is smaller.

13. The non-transitory computer-readable storage medium according to claim 2, wherein the controlling the display includes controlling the display to display a plurality of sets of the image and the evaluation result in association with each other in a screen.

14. The non-transitory computer-readable storage medium according to claim 13, wherein the controlling the display includes controlling the display to display the plurality of sets of the image and the evaluation result in a sorted manner in descending order of the evaluation result.

15. The non-transitory computer-readable storage medium according to claim 2, wherein the controlling the display includes controlling the display to display a low-rating image and the evaluation result in association with recommendation information, the low-rating image being the image of which the evaluation result indicates a lower rating than a particular rating, the recommendation information being information indicating that the image data is more suitable for printing by a printer than processing by the processing apparatus.

16. The non-transitory computer-readable storage medium according to claim 2, wherein the set of instructions, when executed by the controller, causes the image evaluation apparatus to perform:
acquiring a condition of changing the gradation value of each of the plurality of pixels; and
changing the gradation value of each of the plurality of pixels in accordance with the condition; and
wherein the acquiring the feature amount includes acquiring the feature amount of the image data corresponding to the evaluation condition based on the gradation value of each of the plurality of pixels after changing the gradation value.

17. The non-transitory computer-readable storage medium according to claim 12, wherein the estimated processing time is calculated based on a sum of lengths of the line segments, a number of the line segments, a number of the same-color sections, or a number of colors in the image.

18. The non-transitory computer-readable storage medium according to claim 12, wherein the estimated processing time is calculated based on a number of the same-color sections, a number of colors in the image, and at least a sum of lengths of the line segments or a number of the line segments.

19. An image evaluation method performed by a controller of an image evaluation apparatus, the image evaluation method comprising:
acquiring image data representing an image;
acquiring an evaluation condition for determining whether the image data is suitable as data serving as a source for generating processing data used for processing a sheet-like workpiece by a processing apparatus, the evaluation condition being a condition for determining whether the image data is suitable from a viewpoint of at least ease of processing when the workpiece is processed in accordance with the processing data generated based on the image data or reproducibility of the image;
acquiring a feature amount of the image data, the feature amount corresponding to the evaluation condition; and
controlling a display to display a value corresponding to the feature amount of the image data.
